(19) United States
(12) Patent Application Publication
(10) Pub. No.: US 2026/0187411 A1
(43) Pub. Date: Jul. 2, 2026

(54) SEPARATING OBSERVATION AND SYSTEM NOISE IN TIME-SERIES DATA

(71) Applicant: INTERNATIONAL BUSINESS MACHINES CORPORATION, Armonk, NY (US)

(72) Inventors: Kyong Min Yeo, Scarsdale, NY (US); Nam H. Nguyen, Pleasantville, NY (US); Wesley M. Gifford, Yorktown Heights, NY (US); Tsuyoshi Ide, Harrison, NY (US); Eun Kyung Lee, Bedford Corners, NY (US)

(21) Appl. No.: 19/003,718

(22) Filed: Dec. 27, 2024

(51) Int. Cl. G06N 3/044; G06N 3/08

(52) U.S. Cl. CPC G06N 3/044; G06N 3/08

(57) ABSTRACT

Artificial intelligence for time-series data analytics is provided. A first time-series data set is provided to a pre-trained recurrent neural network trained based on a second time-series data set. A prediction of a ground truth state of the first time-series data set is received therefrom. The first time-series data set is provided to a dynamical recurrent neural network trained based on the second time-series data set and the pre-trained recurrent neural network. A noise-reduced prediction of a ground truth system state of the first time-series data set is received therefrom. An estimate of sensor noise is read. The estimate of sensor noise is generated based on the second time-series data set and the pre-trained recurrent neural network. A prediction of a state of the system is generated based on the pre-trained recurrent neural network, the dynamical recurrent neural network, and the estimate of sensor noise.

### BACKGROUND

Manufacturing processes and sensor data analytics can use sensors to measure those processes and/or systems performing those processes. These sensors can output time-series data measurements.

### BRIEF SUMMARY

Embodiments of the present disclosure relate to artificial intelligence for time-series data analytics, e.g., manufacturing and sensor data analytics, and more specifically, to separating observation/sensor noise from system noise using recurrent networks.

According to embodiments of the present disclosure, methods and systems of time-series data analytics are provided.

In some embodiments, a computer-implemented method is provided. The computer-implemented method comprises the following steps. A first time-series data set is provided to a pre-trained recurrent neural network. A prediction of a ground truth state of the first time-series data set is received therefrom. The pre-trained recurrent neural network is trained based on a second time-series data set. The first time-series data set represents output of a sensor measuring a system. The second time-series data set represents output of the sensor measuring the system. The first time-series data set is provided to a dynamical recurrent neural network. A noise-reduced prediction of a ground truth system state of the first time-series data set is received therefrom. The dynamical recurrent neural network is trained based on the second time-series data set and the pre-trained recurrent neural network. An estimate of sensor noise is read. The estimate of sensor noise is generated based on the second time-series data set and the pre-trained recurrent neural network. A prediction of a state of the system is generated based on the pre-trained recurrent neural network, the dynamical recurrent neural network, and the estimate of sensor noise.

In some embodiments, the first time-series data set and/or the second time-series data set comprise a composite noise, the composite noise comprising system noise and sensor noise.

In some embodiments, the dynamical recurrent neural network utilizes multiple-step forecast loss and moment matching of a training data set.

In some embodiments, estimate of sensor noise is an estimated sensor noise of the ground truth state of the second time-series data set.

In some embodiments, the method further comprises obtaining, using a sensor configured to monitor a system, one or more of the first time-series data set and the second time-series data set of the system. The ground truth state of one or more of the first time-series data set and the second time-series data set can include a sensor noise component and a system noise component. The method can further comprise separating the sensor noise component from the system noise component.

In some embodiments, the prediction of a ground truth state of the first time-series data set comprises a probability distribution of a state of the system.

In some embodiments, the training of the dynamical recurrent neural network comprises computing, based on a probability distribution from the pre-trained recurrent neural network, a prior distribution, computing, based on the computed prior distribution and the estimate of sensor noise, a posterior distribution, generating data based on the posterior distribution, and training the dynamical recurrent neural network based on the generated data to obtain a probability distribution of a ground truth state of the system.

In some embodiments, a system is provided. The system comprises a computing node. The computing node comprises a computer readable storage medium having program instructions embodied therewith. The program instructions are executable by a processor of the computing node to cause the processor to perform a method. The method comprises the following steps. A first time-series data set is provided to a pre-trained recurrent neural network. A prediction of a ground truth state of the first time-series data set is received therefrom. The pre-trained recurrent neural network is trained based on a second time-series data set. The first time-series data set represents output of a sensor measuring a system. The second time-series data set represents output of the sensor measuring the system. The first time-series data set is provided to a dynamical recurrent neural network. A noise-reduced prediction of a ground truth system state of the first time-series data set is received therefrom. The dynamical recurrent neural network is trained based on the second time-series data set and the pre-trained recurrent neural network. An estimate of sensor noise is read. The estimate of sensor noise is generated based on the second time-series data set and the pre-trained recurrent neural network. A prediction of a state of the system is generated based on the pre-trained recurrent neural network, the dynamical recurrent neural network, and the estimate of sensor noise.

In some embodiments, the first time-series data set and/or the second time-series data set comprise a composite noise, the composite noise comprising system noise and sensor noise.

In some embodiments, the dynamical recurrent neural network utilizes multiple-step forecast loss and moment matching of a training data set.

In some embodiments, estimate of sensor noise is an estimated sensor noise of the ground truth state of the second time-series data set.

In some embodiments, the method executed by the processor further comprises obtaining, using a sensor configured to monitor a system, one or more of the first time-series data set and the second time-series data set of the system. The ground truth state of one or more of the first time-series data set and the second time-series data set can include a sensor noise component and a system noise component. The method executed by the processor can further comprise separating the sensor noise component from the system noise component.

In some embodiments, the prediction of a ground truth state of the first time-series data set comprises a probability distribution of a state of the system.

In some embodiments, the training of the dynamical recurrent neural network comprises computing, based on a probability distribution from the pre-trained recurrent neural network, a prior distribution, computing, based on the computed prior distribution and the estimate of sensor noise, a posterior distribution, generating data based on the posterior distribution, and training the dynamical recurrent neural network based on the generated data to obtain a probability distribution of a ground truth state of the system.

In some embodiments, a computer-implemented method is provided. The computer-implemented method comprises the following steps. A first time-series data set is received. The first time-series data set represents measurements made by a sensor of a system. A prior recurrent neural network (Prior-RNN) is trained based on the first time-series data set. The trained Prior-RNN is configured to predict a ground truth state of a second time-series data set. A dynamical recurrent neural network (Dyn-RNN) is trained based on the first time-series data set and the Prior-RNN. The trained Dyn-RNN thereby is trained to determine a noise-reduced prediction of a ground truth system state of the second time-series data set. An estimate of sensor noise of the system is generated based on the Prior-RNN and the first time-series data set.

In some embodiments, the first time-series data set and/or the second time-series data set comprise a composite noise, the composite noise comprising system noise and sensor noise.

In some embodiments, the dynamical recurrent neural network utilizes multiple-step forecast loss and moment matching of a training data set.

In some embodiments, the method includes obtaining, using a sensor configured to monitor a system, one or more of the first time-series data set and the second time-series data set of the system. The ground truth state of one or more of the first time-series data set and the second time-series data set can include a sensor noise component and a system noise component. The method can include separating the sensor noise component from the system noise component.

In some embodiments, the first time-series data set comprises a ground truth state including a sensor noise component. Training the Dyn-RNN can be further based on the ground truth state and the sensor noise component.

The method of claim 15, wherein the prediction of a ground truth state of the second time-series data set comprises a probability distribution of a state of the system.

### BRIEF DESCRIPTION OF THE DRAWINGS

FIG. 1 is a graph illustrating manufacturing time-series data according to embodiments of the present disclosure.

FIG. 2 is a graph illustrating the true width of the 95% prediction interval for a data set and the width of the 95% prediction interval according to a conventional linear auto-regressive process applied to the data set.

FIG. 3 is a flowchart illustrating a method according to embodiments of the present disclosure.

FIG. 4 is a flowchart illustrating a method according to embodiments of the present disclosure.

FIG. 5 is a flowchart illustrating an algorithm to train a predictive recurrent neural network (Dyn-RNN) according to embodiments of the present disclosure.

FIGS. 6A-6B is a set of graphs illustrating the uncertainty in a time-series data set according to a standard recurrent neural network (RNN) and according to embodiments of the present disclosure.

FIG. 7 is a diagram illustrating examples of different physical and virtual layers and virtual instances for power accounting in some cloud computing applications according to embodiments of the present disclosure.

FIG. 8 is a graph illustrating threshold-based failure prediction according to embodiments of the present disclosure.

FIG. 9 is a graph illustrating etching endpoint detection in some semiconductor manufacturing applications according to embodiments of the present disclosure.

FIG. 10 is a graph illustrating lens replacement scheduling in optical measurement systems according to embodiments of the present disclosure.

FIG. 11 is a diagram illustrating an example system of estimating ground truth and noise according to embodiments of the present disclosure.

FIG. 12 is a schematic illustrating a computing node according to embodiments of the present disclosure.

### DETAILED DESCRIPTION

In some embodiments of manufacturing, industrial, and other processes, time-series data collected by sensors are used to monitor those processes. However, on top of the natural randomness of the system (system noise), noise can be introduced at those sensors, causing signal noise. The time-series data can be corrupted by such sensor noise. In some embodiments of the present disclosure, a model is used to provide an estimate of sensor noise in the time-series data. In some embodiments, the estimate can be used to reduce the noise in the time-series data.

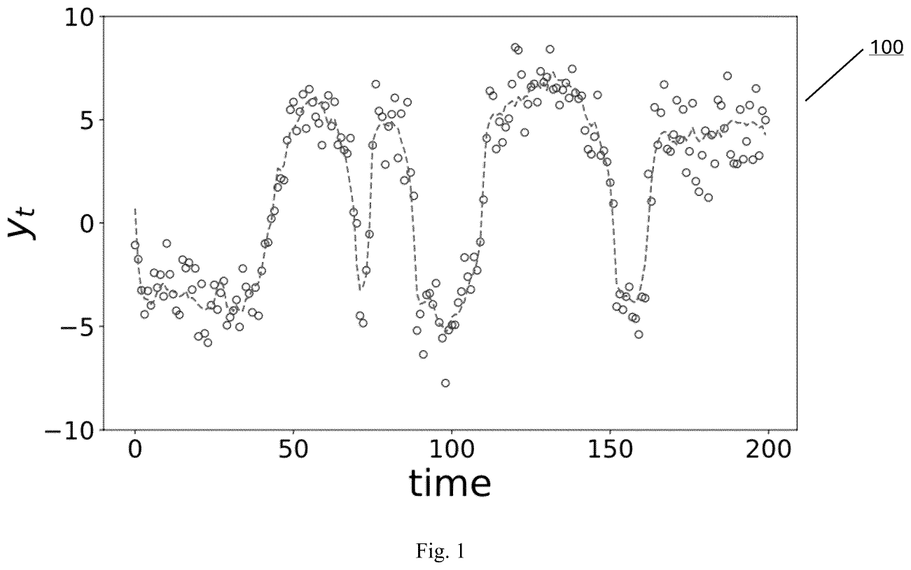

FIG. 1 is a graph 100 illustrating time-series data (e.g., manufacturing data, etc.) according to embodiments of the present disclosure. In the example of FIG. 1, time-series data, such as manufacturing or industrial time-series data, can be corrupted by the introduction of sensor noise. The introduction of such noise can result in noisy sensor measurements. While the time-series data is meant to represent an underlying complex physical process that is stochastic and unknown, the ground truth stochastic process, μ, is not observable. As a result, a model trained on the noisy sensor measurement may overestimate uncertainty of that stochastic process. Therefore, it is desirable to separate the ground truth state from the sensor noise for a better control of the system. Such a ground truth process can be represented by Equation 1, below:

$$\frac{d μ ( t )}{dt} = ℱ ( μ ( t ) , μ ( t - τ ) , v ( t ) ) + ϵ ( t ) , \qquad ( 1 )$$

$${y}_{i} = {μ}_{i} + {η}_{t} ,$$

where μ represents the ground truth, y represents the observation, τ represents a time-delay parameter, v represents control sequences, ϵ represents system noise, and η represents sensor noise. The time-delay parameter represents a delayed response of the system to changes in the environment.

In alternative methods, the time evolution of the observation can be learned from a probability distribution denoted as p(yₜ₊₁|y_{1:t}). Equation 2, below, can provide a prediction of the time evolution of the observation, where y represents the observation:

$$p ( {y}_{t + h} \vert {y}_{1 : t} ) = \int {\prod }_{i = 1}^{h} p ( {y}_{t + i} \vert {y}_{1 : t + i - 1} ) p ( {y}_{t} \vert {y}_{1 : t - 1} ) {dy}_{t + 1 : t + h - 1} . \qquad ( 2 )$$

Equation 3, below, represents the true probability distribution of the process (e.g., based on the ground truth):

$$p ( {y}_{t + h} \vert {y}_{1 : t} ) = \int p ( {y}_{t + h} \vert {μ}_{t + h} ) {\prod }_{i = 1}^{h} p ( {μ}_{t + i} \vert {μ}_{1 : t + i - 1} ) p ( {μ}_{1 : t} \vert {y}_{1 : t} ) d {μ}_{1 : t + h} \qquad ( 3 )$$

where y represents the observation and μ represents the ground truth.

The term p(μₜ₊₁|μ_{1:t+i-1}) is common to both the prediction of the time evolution of the observation of Equation 2 and the true probability distribution of the process of Equation 3, as defined above. While the true uncertainty of the system is reflected in Equation 4a, the prediction (e.g., of Equation 2) overestimates the uncertainty by summing up the sensor noise and the system noise, which is reflected in Equation 4b below:

$${μ}_{t + 1} = f ( {μ}_{t} ) + {ϵ}_{t} and \qquad ( 4 a )$$

$${y}_{t + 1} = g ( {y}_{t} ) + {ϵ}_{t} + {η}_{t} , \qquad ( 4 b )$$

where y is the observation, μ is the ground truth, ϵₜ is the system noise, ηₜ and is the sensor noise.

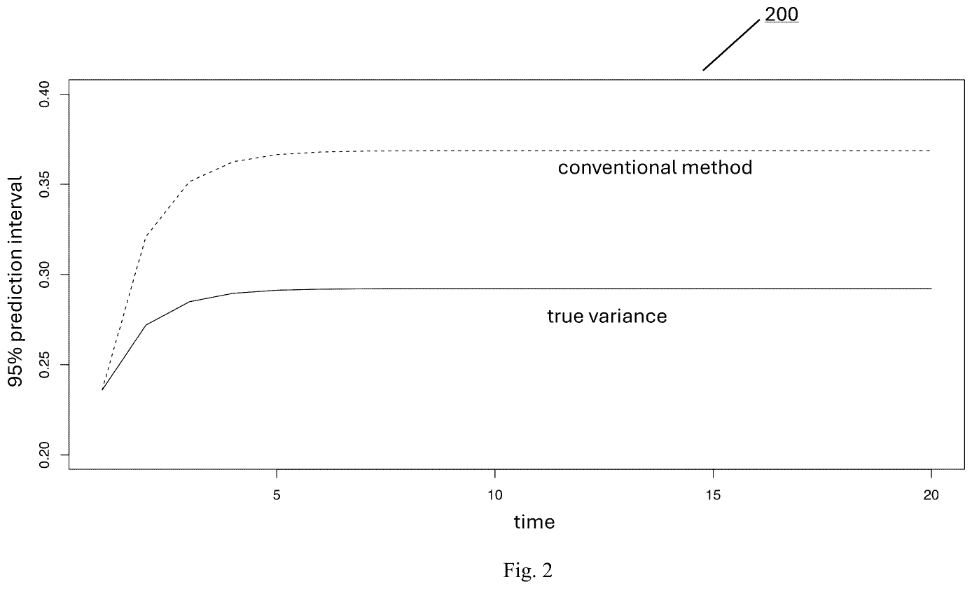

FIG. 2 is a graph 200 illustrating a conventional linear auto-regressive process of estimating error of a ground truth process μ measured by observations y with system noise ϵₜ and sensor noise ηₜ, as illustrated by Equations 5a and 5b, below;

$${μ}_{t} = c {μ}_{t - 1} + {ϵ}_{t} , and \qquad ( 5 a )$$

$${y}_{t} = {μ}_{t} + {η}_{t} \qquad ( 5 b )$$

The graph 200 compares the estimated error true variance of that process. As is shown by graph 200, conventional methods of prediction for manufacturing time-series data overestimate uncertainty.

One problem with alternative methods is that the system noise and the observation noise are not separable without an observation of the ground-truth system state. In these alternative methods, only the composite noise \hat{η}ₜ can be learned, and not the individual components of that noise. This relationship is shown in Equation 6 below:

$${y}_{t} = {μ}_{t} + {η}_{t} = f ( {μ}_{t - 1} ) + {ϵ}_{t} + {η}_{t} = f ( {μ}_{t - 1} ) + {\hat{η}}_{t} \qquad ( 6 )$$

where y is the observation, μ is the ground truth, ϵ is the system noise, η is the sensor noise, and \hat{η} is the composite noise.

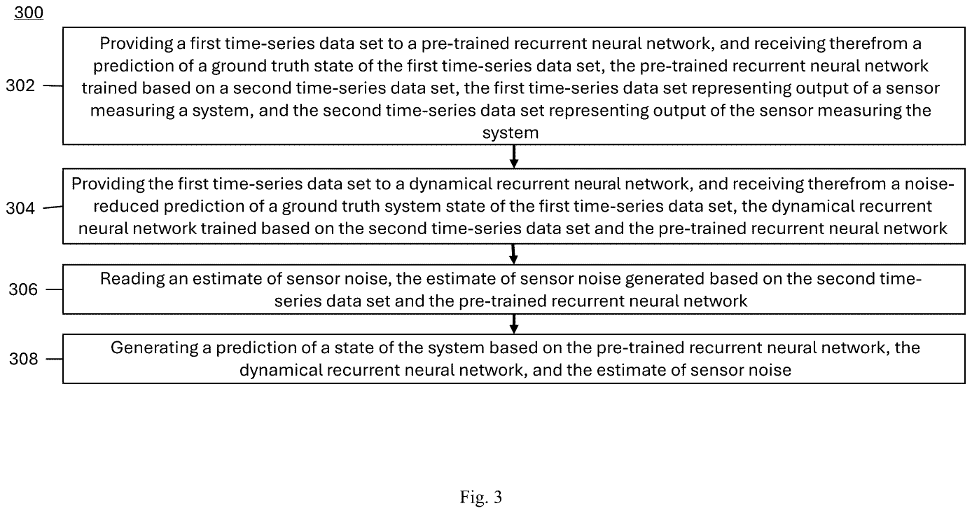

FIG. 3 is a flowchart 300 illustrating a method according to embodiments of the present disclosure. In some embodiments, at 302, a first time-series data set is provided to a pre-trained recurrent neural network. A prediction of a ground truth state of the first time-series data set is received therefrom. The pre-trained recurrent neural network is trained based on a second time-series data set. The first time-series data set represents output of a sensor measuring a system. The second time-series data set represents output of the sensor measuring the system. In some embodiments, at 304, the first time-series data set is provided to a dynamical recurrent neural network. A noise-reduced prediction of a ground truth system state of the first time-series data set is received therefrom. The dynamical recurrent neural network is trained based on the second time-series data set and the pre-trained recurrent neural network. In some embodiments, at 306, An estimate of sensor noise is read. The estimate of sensor noise is generated based on the second time-series data set and the pre-trained recurrent neural network. In some embodiments, at 308, a prediction of a state of the system is generated based on the pre-trained recurrent neural network, the dynamical recurrent neural network, and the estimate of sensor noise.

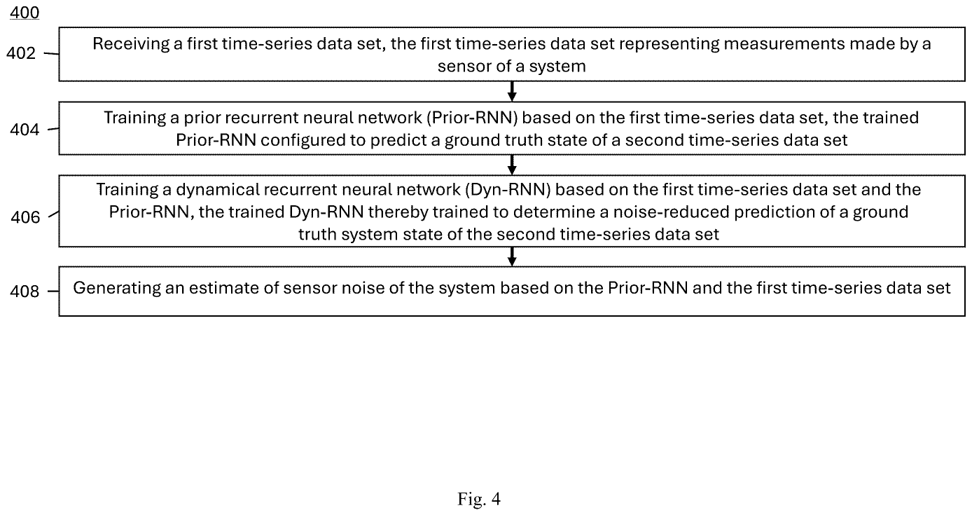

FIG. 4 is a flowchart illustrating a method according to embodiments of the present disclosure. In some embodiments, at 402, a first time-series data set is received. The first time-series data set represents measurements made by a sensor of a system. In some embodiments, at 404, a prior recurrent neural network (Prior-RNN) is trained based on the first time-series data set. The trained Prior-RNN is configured to predict a ground truth state of a second time-series data set. In some embodiments, at 406, a dynamical recurrent neural network (Dyn-RNN) is trained based on the first time-series data set and the Prior-RNN. The trained Dyn-RNN thereby determines a noise-reduced prediction of a ground truth system state of the second time-series data set. In some embodiments, at 408, an estimate of sensor noise of the system is generated based on the Prior-RNN and the first time-series data set.

According to some embodiments of the present disclosure, multiple neural networks, (e.g., a dynamical recurrent neural network (Dyn-RNN) and a standard recurrent neural network for a prior distribution (Prior-RNN)) may be used according to Equation 7 below:

$$p ( {y}_{t + h} \vert {y}_{1 : t} ) = \int p ( {y}_{t + h} \vert {μ}_{t + h} ) {\prod }_{i = 1}^{h} p ( {μ}_{t + i} \vert {μ}_{1 : t + i - 1} ) p ( {μ}_{1 : t} \vert {y}_{1 : t} ) d {μ}_{1 : t + h} \qquad ( 7 )$$

where y is the observation, μ is the ground truth, p(yₜ₊ₕ|μₜ₊ₕ) is learnable noise p(μₜ₊ᵢ|μ_{1:t+i-1}) is a ground truth state determined by the dynamical recurrent neural network (Dyn-RNN), and p(μ_{1:t}|y_{1:t}) is a ground truth state determined by the standard recurrent neural network (Prior-RNN).

According to some embodiments of the present disclosure, the system and observation/sensor noises are separable in a multiple-step forecast. For example, Equations 8a and 8b below represent a linear autoregressive model:

$${μ}_{t} = c {μ}_{t - 1} + {ϵ}_{t} , \\ {y}_{t} = {μ}_{t} + {η}_{t} , \qquad ( 8 a )$$

$${y}_{t + h} \vert {y}_{t} ∼ 𝒩 ( {y}_{t + h} \vert {c}^{h} {y}_{t} , \frac{1 - {c}^{2 h}}{1 - {c}^{2}} {σ}_{ϵ}^{2} + ( 1 + {c}^{2 h} ) {σ}_{η}^{2} ) \qquad ( 8 b )$$

where μ is the ground truth, y is the observation, ϵ is the system noise, and η is the sensor noise. Since the system noise and observation noise have different growth factors, they can be distinguished in a multiple-step forecast.

According to some embodiments of the present disclosure, the ground truth state of a random dynamical system is modeled by a dynamical recurrent neural network (Dyn-RNN) according to Equations 9a and 9b below:

$$p ( {μ}_{t} \vert {μ}_{1 : t - 1} ) = 𝒩 ( {μ}_{t} \vert {m}_{t}^{μ} , {\sum }_{t}^{μ} ) , \qquad ( 9 a )$$

$$[ {m}_{i}^{μ} , {σ}_{i}^{μ} , {h}_{i}^{μ} ] = {Ψ}^{μ} ( {μ}_{i - 1} , {h}_{i - 1}^{μ} ; {θ}^{μ} ) , \qquad ( 9 b )$$

where m represents the mean of the predictive probability distribution, Σ represents the covariance of the predictive probability distribution, μ represents the ground truth, h represents the hidden state of Dyn-RNN, θ represents the parameters of Dyn-RNN, and σ represents the diagonal elements of Σ.

According to some embodiments of the present disclosure, the prior distribution of the ground truth is modeled by a standard recurrent neural network (Prior-RNN) according to Equations 10a and 10b below:

$$q ( {μ}_{t} \vert {y}_{1 : t - 1} ) = 𝒩 ( {μ}_{t} \vert {m}_{t}^{q} , {\sum }_{t}^{q} ) \qquad ( 10 a )$$

$$[ {m}_{i}^{q} , {σ}_{i}^{q} , {h}_{i}^{q} ] = {Ψ}^{q} ( {y}_{i - 1} , {h}_{i - 1}^{q} ; {θ}^{q} ) \qquad ( 10 b )$$

where μ is the ground truth and y is the observation.

According to some embodiments of the present disclosure, a recurrent neural network (Prior-RNN) can estimate the composite variance

$${\sum }_{t}^{y} = {\sum }_{t}^{q} + {\sum }^{η} ,$$

where y is the observation and Σ^{η} is the estimated sensor noise. The Prior-RNN is trained using a standard recurrent neural network (RNN) training with back-propagation through time. Using a predictive RNN (Dyn-RNN), moment matching is performed according to Equations 11a-c below, where μ is the ground truth, y is the observation, and Σ^{η} is the learnable variance, (e.g., the estimated sensor noise):

$${E}_{{p}_{d}} [ {y}_{t} ] = {E}_{{p}_{μ}} [ {y}_{t} ] , and {V}_{{p}_{d}} [ {y}_{t} ] = {V}_{{p}_{μ}} [ {y}_{t} ] {E}_{{p}_{μ}} [ {y}_{t} ] ≃ \frac{1}{M} {\sum }_{i = 1}^{M} {m}_{t}^{μ ( i )} , \qquad ( 11 a )$$

$$\begin{matrix}{V}_{{p}_{μ}} [ {y}_{t} ] ≃ {\sum }^{η} + \frac{1}{M} {\sum }_{i = 1}^{M} {\sum }_{t}^{μ ( i )} + \{ \frac{1}{M} {\sum }_{i = 1}^{M} {m}_{t}^{{μ ( i )}^{2}} - {( \frac{1}{M} {\sum }_{i = 1}^{M} {m}_{t}^{μ ( i )} )}^{2} \} \\ = {\sum }^{η} + \overline{{\sum }_{t}^{μ}} + {\sum }_{t}^{MC} ,\end{matrix} \qquad ( 11 b )$$

$${ℒ}_{t}^{μ} = \frac{1}{2} {E}_{{p}_{d}} [ {( {y}_{t} - {E}_{{p}_{μ}} [ {y}_{t} ] )}^{T} {V}_{{p}_{μ}}^{- 1} [ {y}_{t} ] ( {y}_{t} - {E}_{{p}_{μ}} [ {y}_{t} ] ) + log \vert {V}_{{p}_{μ}} [ {y}_{t} ] \vert ] . \qquad ( 11 c )$$

The Dyn-RNN model can also perform a multiple-step forecast with a multiple-step predictive distribution according to Equation 12 below, where μ is the ground truth, y is the observation, and Σ^{η} is the learnable variance, e.g., the estimated sensor noise:

$$\begin{matrix}{p}_{μ} ( {y}_{T + h} \vert {y}_{1 : T} ) = \int p ( {y}_{T + h} \vert {μ}_{T + h} ) [ {\prod }_{j = 1}^{h - 1} p ( {μ}_{T + j + 1} \vert {μ}_{1 : T + j} ) ] \\ [ {\prod }_{i = 1}^{T} p ( {μ}_{i + 1} \vert {μ}_{1 : i} ) p ( {μ}_{1 : T} \vert {y}_{1 : T} ) ] d {μ}_{1 : T + h} \\ = {E}_{{μ}_{T + 1 : T + h}}^{μ} [ {E}_{{μ}_{1 : T}}^{po} [ 𝒩 ( {y}_{T + h} \vert {m}_{T + h}^{μ} , {\sum }_{T + h}^{μ} + {\sum }^{η} ) ] ] .\end{matrix} \qquad ( 12 )$$

The above-described moment matching can result in Equation 13 below, where μ is the ground truth and y is the observation:

$${ℒ}_{i}^{F} = \frac{1}{2} {E}_{{p}_{d}} [ \text{} {( {y}_{T + i} - {E}_{{p}_{μ}} [ {y}_{T + i} ] )}^{T} {V}_{{p}_{μ}}^{- 1} [ {y}_{T + i} ] ( {y}_{T + i} - {E}_{{p}_{μ}} [ {y}_{T + i} ] ) + log \vert {V}_{{p}_{μ}} [ {y}_{T + i} ] \vert ] . \qquad ( 13 )$$

The prior variance is estimated by subtracting the learnable variance Σ^{η} (e.g., the estimated sensor noise) from the composite variance

$${\sum }_{t}^{y} , as {\sum }_{t}^{q} = max ( {\sum }_{t}^{y} - {\sum }^{η} , e ) ,$$

where e=10⁻¹⁰, y is the observation. The total loss can be represented by

$${ℒ}^{dyn} ( {θ}^{μ} , {\sum }^{η} ; {θ}^{q} ) = \frac{1}{T - 1} {\sum }_{t = 2}^{7 '} {ℒ}_{t}^{μ} + \frac{1}{h} {\sum }_{i = 1}^{h} {ℒ}_{i}^{F} ,$$

where μ is the ground truth and Σ^{η} is the learnable variance, (e.g., the estimated sensor noise).

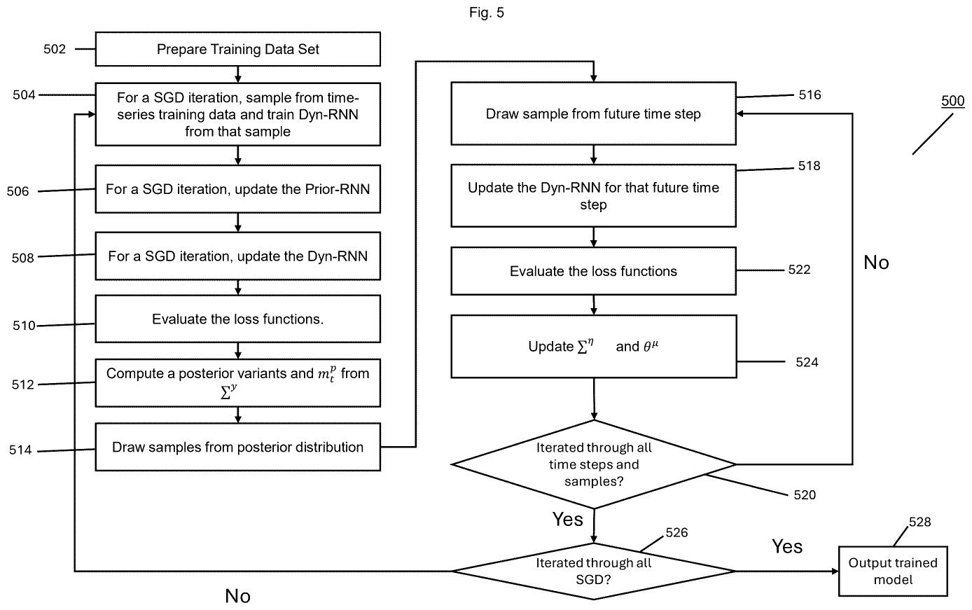

FIG. 5 is a flowchart 500 illustrating a method of training a dynamical recurrent neural network (Dyn-RNN) and a standard recurrent neural network according to embodiments of the present disclosure. For each training data set [symbol] ^{train} comprising a set of length-T+h time-series, (y_{1:T+h}, v_{1:T+h}), is prepared from time-series data [symbol] , where y is the observation, v is the control sequence, T is the length of the training sequence, and h is the length of the forecasting sequence (502). The method performs the below described computation for the values 1 to the maximum number of stochastic gradient descent iterations kₘₐₓ of the iteration count k (526). A mini-batch of size n_{b} can be randomly sampled from [symbol] ^{train} (504). The learnable variance, [symbol] which is equivalent to the estimated sensor noise, can be computed as Σ^{η}=diag(exp(z)). M Monte Carlo samples can be drawn for

$${μ}_{1} ; {μ}_{1}^{( i )} ∼ 𝒩 ( {y}_{1} , C ( {\sum }^{η} ) ) ,$$

where μ represents the ground truth. The variables

$${h}_{1}^{q} and {h}_{1}^{μ}$$

can be set to zero. The loss [symbol] can also be set to zero.

For the t-values 2 through T, a prior recurrent neural network (Prior-RNN) can be updated according to the equation

$$[ {m}_{t}^{q} , {σ}_{t}^{y} , {h}_{t}^{q} ] = {Ψ}_{q} ( {y}_{t - 1} , {v}_{t - 1} , {h}_{t - 1}^{q} ) ,$$

where Ψ_{q} is the Prior-RNN (506). The prior variance

$${\sum }_{t}^{q}$$

can also be set to

$$max ( diag ( {σ}_{t}^{y} ) - C ( {\sum }^{η} ) , e ) .$$

In addition, for the i-values 1 and M, a dynamical recurrent neural network (Dyn-RNN) can be updated according to the equation

$$[ {m}_{t}^{μ ( i )} , {σ}_{t}^{μ ( i )} , {h}_{t}^{μ ( i )} ] = {Ψ}_{μ} ( {μ}_{t - 1}^{( i )} , {v}_{t - 1} , {h}_{t - 1}^{μ ( i )} ) . \qquad ( 508 )$$

The loss functions can be also evaluated with the loss equation

$$ℒ = ℒ + \frac{1}{T - 1} {ℒ}_{t}^{μ} . \qquad ( 510 )$$

The posterior mean and variance and

$${m}_{t}^{p} and {\sum }_{t}^{p}$$

can also be computed using

$${\sum }_{t}^{y}$$

with the learnable noise, Σ^{η} (512). In addition, M Monte Carlo samples can be drawn from the posterior distribution

$${μ}_{t}^{( i )} \sim 𝒩 ( {m}_{t}^{p} , {\sum }_{t}^{p} ) . \qquad ( 514 )$$

The steps 506, 508, 510, 512, and 514 are iterated for each of the t-values 2 through T.

The method then iterates through the t-values T+1 through T+h. For each of those values, the method also iterates through the i-values 1 through M. For each iteration of the i-values, the Dyn-RNN can be updated according to the equation

$$[ {m}_{t}^{μ ( i )} , {σ}_{t}^{μ ( i )} , {h}_{t}^{μ ( i )} ] = {Ψ}_{μ} ( {μ}_{t - 1}^{( i )} , {v}_{t - 1} , {h}_{t - 1}^{μ ( i )} ) . \qquad ( 518 )$$

A sample can be drawn for the next time step from the distribution

$${μ}_{t}^{( i )} ! \sim 𝒩 ( {m}_{t}^{μ ( i )} , {\sum }_{t}^{μ ( i )} ) . \qquad ( 516 )$$

For each iteration of the t-values T+1 through T+h, the loss functions can also be evaluated:

$$ℒ = ℒ + \frac{1}{h} {ℒ}_{t}^{F} . \qquad ( 522 )$$

Once all iterations of i- and t-values are complete (520), for each the estimated sensor noise can be updated as Σ^{η}: z=z−α∇_{z} [symbol] and the initial parameters are updated based on θ^{μ}:θ^{μ}=θ^{μ}−α∇_{θ}_{^{η}} [symbol] , where α is the learning rate and (θ^{μ}, z) are the initial parameters (524). The resulting trained Dyn-RNN can be outputted (528).

The method 500 illustrated by FIG. 5 is further described in relation to Method 1 below. Method 1 illustrates the iterations of the above method in further detail.

Method 1 - Training of a Dyn-RNN

```
Input: Time series data ( [symbol]  ), size of the mini-batch (n_{b}), size of the Monte Carlo sam-
ples (M), length of the training sequence (T), length of the forecasting sequence (h),
learning rate (α), regularization coefficient (λ), maximum number of SGD iteration
(kₘₐₓ), trained Prior-RNN (Ψ_{q}), initial parameters (θ^{μ}, z)
  1: Prepare a training data ( [symbol] ^{train}), which consists of a set of length T + h time
    series, (y_{1:T+h}, v_{1:T+h}), from [symbol]
  2: for k = 1, kₘₐₓ do
  3: Randomly sample a mini-batch of size n_{b} from [symbol]   ^{train}
  4: Compute Ξ = diag(exp(z))
  5:  $Draw M samples for {μ}_{1} ; {μ}_{1}^{( i )} ∼ 𝒩 ( {y}_{1} , 𝒞 ( Ξ ) )$
  6:  $Set {h}_{1}^{q} = {h}_{1}^{μ} = 0$
  7: Set [symbol]  = 0
  8: for t = 2, T do
  9:  $Update Prior - RNN : [ {m}_{t}^{q} , {σ}_{t}^{y} , {h}_{t}^{q} ] = {Ψ}_{q} ( {y}_{t - 1} , {v}_{t - 1} , {h}_{t - 1}^{q} )$
10:  $Set {\sum }_{t}^{q} = max ( diag ( {σ}_{t}^{y} ) - 𝒞 ( Ξ ) , e )$
11: for i = 1, M do
12:  $Update Dyn - RNN : [ {m}_{t}^{μ ( i )} , {σ}^{μ ( i )} , {h}_{t}^{μ ( i )} ] = {Ψ}_{μ} ( {μ}_{t - 1}^{( i )} , {v}_{t - 1} , {h}_{t - 1}^{{μ}^{( i )}} )$
13: end for
14:  $Evaluate the loss functions , ℒ = ℒ + \frac{1}{T - 1} {ℒ}_{t}^{μ}$
15:  $Compute {m}_{t}^{p} and {\sum }_{t}^{p} from$
${m}_{f}^{p} = {m}_{t}^{q} + {\sum }^{g} {( Ξ + {\sum }_{t}^{q} )}^{- 1} ( {y}_{t} - {m}_{t}^{q} ) , {\sum }_{t}^{p} = {\sum }_{t}^{q} {( Ξ + {\sum }_{t}^{q} )}^{- 1} Ξ . ,$
      $using diag ( {σ}_{t}^{y} ) instead of ( {\sum }_{t}^{p} + Ξ )$
16:  $Draw M samples from the posterior distribution : {μ}_{t}^{( i )} ∼ 𝒩 ( {m}_{t}^{p} , {\sum }_{t}^{p} )$
17: end for
18: for t = T + 1, T + h do
19: for i = 1, M do
20:  $Update Dyn - RNN : [ {m}_{t}^{μ ( i )} , {σ}_{t}^{μ ( i )} {h}_{t}^{μ ( i )} ] = {Ψ}_{μ} ( {μ}_{t - 1}^{( i )} , {v}_{t - 1} , {h}_{t - 1}^{{μ}^{( i )}} )$
21:  $Draw a sample for the next time step : {μ}_{t}^{( i )} ∼ 𝒩 ( {m}_{t}^{μ ( i )} , {\sum }_{t}^{μ ( ι )} )$
22: end for
23:  $Evaluate the loss functions , ℒ = ℒ + \frac{1}{h} {ℒ}_{t}^{F}$
24: end for
25: Update Σ^{η}: z = z − α∇_{z} [symbol]
26: Update θ^{μ}: θ^{μ} = θ^{μ} − α∇_{θ}_{^{μ}} [symbol]
27: end for
```

According to some embodiments of the present disclosure, inference can be calculated using the Prior-RNN and Dyn-RNN. Prior-RNN, the standard recurrent neural network, can be updated from yₜ₋₁ according to

$$q ( {μ}_{t} \vert {y}_{1 : t - 1} ) = 𝒩 ( {μ}_{t} \vert {m}_{t}^{q} , {\sum }_{t}^{q} ) ,$$

where y is the observation and μ is the ground truth. A posterior distribution can be computed from Prior-RNN and a new observation yₜ according to Equation 14 below:

$$p ( {μ}_{t} \vert {y}_{1 ; t} ) = 𝒩 ( {μ}_{t} \vert {m}_{t}^{q} , {\sum }_{t}^{q} ) , \qquad ( 14 )$$

$${m}_{t}^{p} = {m}_{t}^{q} + {\sum }^{q} {( {\sum }^{η} + {\sum }_{t}^{q} )}^{- 1} ( {y}_{t} - {m}_{t}^{q} )$$

$$where {\sum }_{t}^{p} = {\sum }_{t}^{q} {( {\sum }^{η} + {\sum }_{t}^{q} )}^{- 1} {\sum }^{η} .$$

Samples can be drawn from the posterior distribution

$${μ}_{t}^{*} = {μ}_{t}^{p} + {σ}_{t}^{p} ζ .$$

Dyn-RNN, a dynamical recurrent neural network, can be updated from the samples:

$$p ( {μ}_{t + 1} \vert {μ}_{1 : t}^{*} )$$

where

$$[ {m}_{i + 1}^{μ} , {σ}_{i + 1}^{μ} , {h}_{i + 1}^{μ} ] = {Ψ}^{μ} ( {μ}_{i}^{*} , {h}_{i}^{u} ) .$$

According to some embodiments of the present disclosure, a multiple-step forecast is performed as follows. Using the inference step, Prior-RNN, a standard recurrent neural network, and Dyn-RNN, a dynamical recurrent neural network, can be updated up to the observation yₜ. Samples can be drawn from the Dyn-RNN:

$${μ}_{t + i} = {m}_{t + i}^{μ} + {σ}_{t + i}^{μ} ζ ,$$

where, μ is the ground truth. Dyn-RNN can be updated from the samples:

$$[ {m}_{t + i + 1}^{μ} , {σ}_{t + i + 1}^{μ} , {h}_{t + i + 1}^{μ} ] = {Ψ}^{μ} ( {μ}_{t + i} , {h}_{t + i}^{μ} ) .$$

The steps of drawing samples from Dyn-RNN and updating Dyn-RNN from the samples can be iterated or repeated.

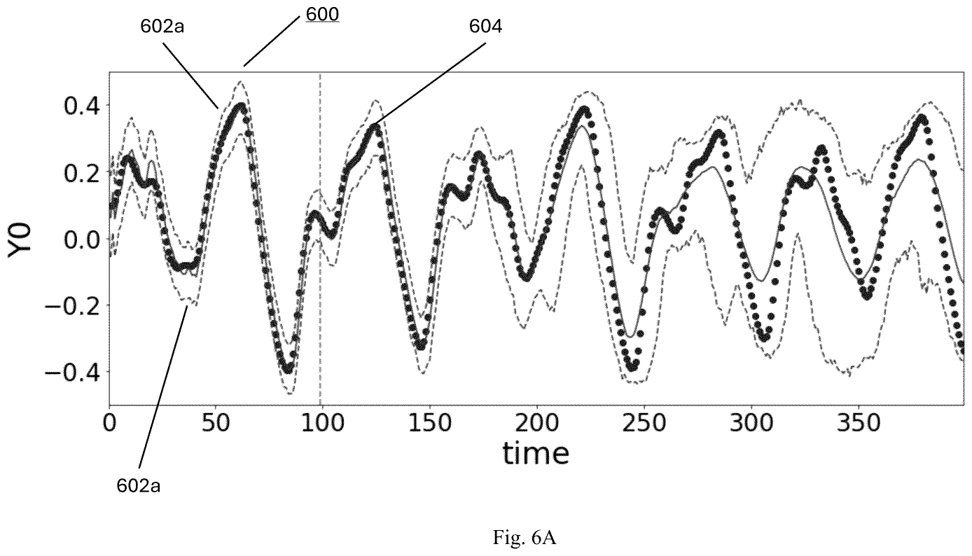

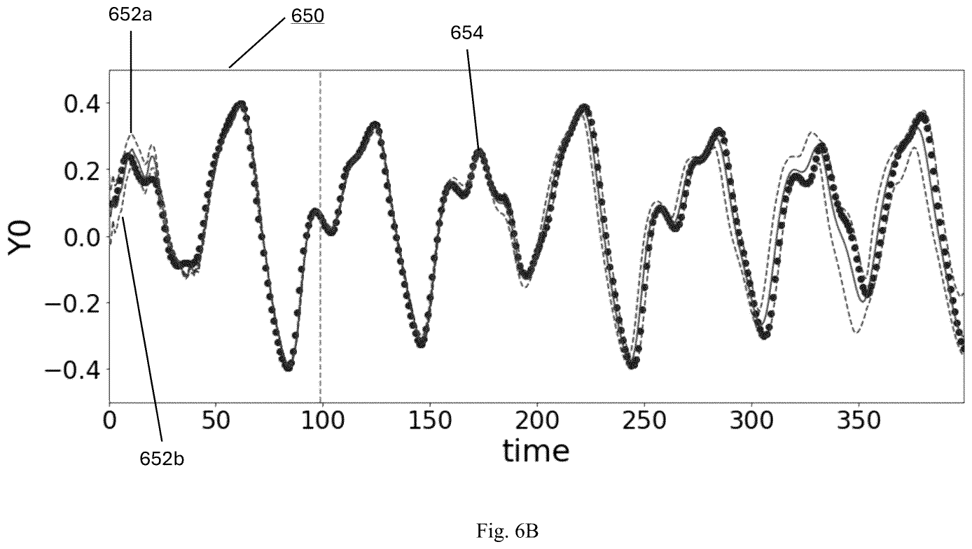

FIG. 6A is a graph 600 illustrating uncertainty in a deterministic Mackey-Glass time-series data set of noisy observations 604 based on a standard recurrent neural network (RNN) according to embodiments of the present disclosure. The graph 600 illustrates that data can remain noisy, as illustrated by the wide gap between the upper and lower bounds of confidence 602a-b.

FIG. 6B is a graph 650 illustrating the uncertainty in a deterministic Mackey-Glass time-series data set of noisy observations 654 according to some embodiments of the present disclosure. The noise in the data is reduced by the forecast, as shown by the smaller gap between the upper and lower bounds of confidence 652a-b.

According to some embodiments of the present disclosure, historic multi-variate time series data is assumed for the training phase, and streaming data from a sensor network is assumed for the monitoring phase. According to some embodiments of the present disclosure, two sets of outputs are generated: estimated sensor noise, and a forecast of the ground truth state without the sensor noise. According to some embodiments of the present disclosure, there are a wide range of business applications, including, for example, application to temperature and/or pressure sensor data of a blast furnace, and application to the bearing vibration and/or speed of a wind turbine.

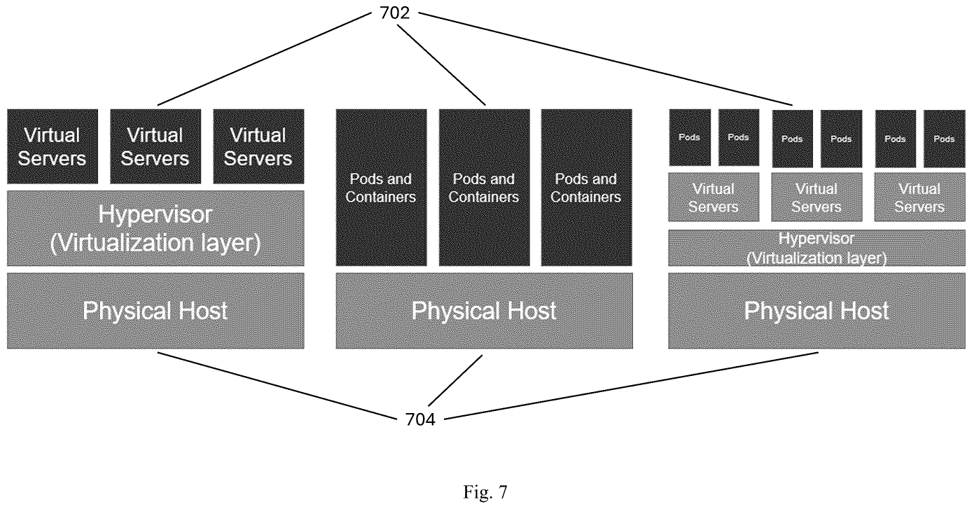

FIG. 7 is a diagram 700 illustrating examples of different physical and virtual layers 704 and virtual instances 702 for power accounting in some cloud computing applications according to embodiments of the present disclosure. There is an increasing need for power and/or energy estimation for virtualized instances because of their efficient energy use and energy accounting. Virtual servers, pods, and containers in multiple levels of virtualized technology make the energy accounting/measurement error-prone. In some examples, measurement error can originate from the physical sensors and system-imposed error (e.g., measurement error, time-shifted measurements, estimation error from different virtualization layers). Some embodiments of the present disclosure can be used to separate the measurement noise from the ground truth state to allow for more efficient control of the computing system.

In a cloud server system for some cloud computing applications, multiple sensors in cloud servers can be used to detect any malfunctions of the server and avoid them according to embodiments of the present disclosure. Examples of such sensors include power sensors for CPU sockets, mem, CPU, and GPU, frequency sensors for CPU, temperature sensors for the CPU core, sockets, Board Management Controller (BMC), and other components (GPU, mem, NIC), and fan speed sensors for the server and heat sync. Inaccurate measurements can lead to system failure and/or inefficient control of the servers (e.g., server overcooling, wasting of energy, slowing down of the application). Measurement error can originate from the physical sensors and system-imposed error (e.g., measurement error, time-shifted measurements, estimation error from the system). Some embodiments of the present disclosure can be used to separate the measurement noise from the ground truth state to allow for improved control of the system.

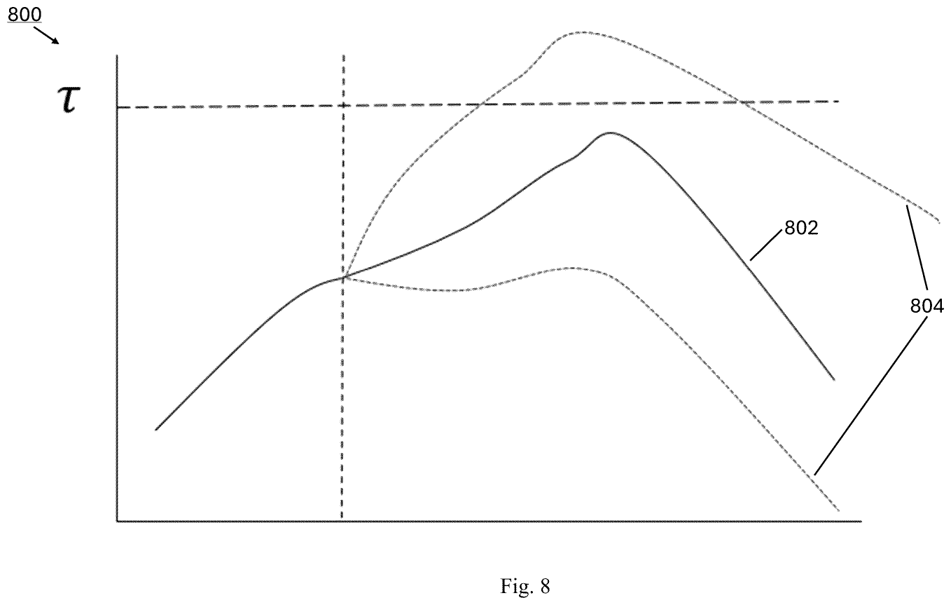

FIG. 8 is a graph 800 illustrating threshold-based failure prediction according to embodiments of the present disclosure. According to some embodiments of the present disclosure, system failure, e.g., for a blast furnace or chemical reactor, due to an excursion event can be predicted based on a ground truth value μₜ 802 and its relation to a threshold τ. For instance, system failure can be predicted if μₜ>τ or μₜ<τ. A failure score fₜ=P(μₜ>τ) can be calculated. Overestimation of errors, as in the error range 804, of the prediction interval, as in conventional methods of prediction for manufacturing time-series data, can lead to more false positives.

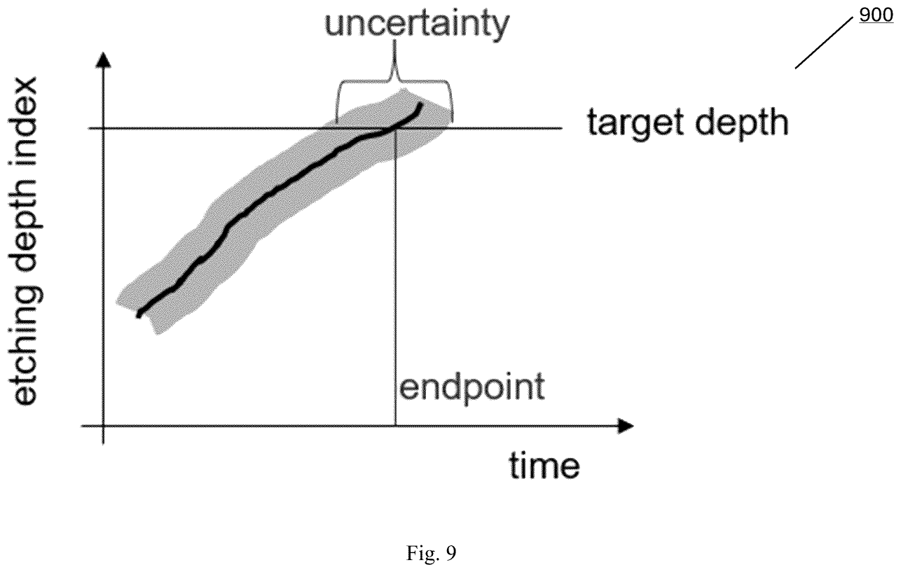

FIG. 9 is a graph 900 illustrating etching endpoint detection in some semiconductor manufacturing applications of some embodiments of the present disclosure. Precise estimation of hidden system dynamics is advantageous in endpoint detection, e.g., the task of determining when to stop etching during plasma etching. To estimate such dynamics for plasma etching, real-time optical measurement spectra (OES) are used to infer the physical condition of the wafer surface. At a given point in time, an OES spectrum can be viewed as a high-dimensional vector, yₜ, where each dimension specifies a wavelength λ, and its value corresponds to the intensity of light. However, the OES signal can often be noisy due to surface contamination. Some embodiments of the present disclosure can be used to handle the noise in the OES signal-using a “cleansed” signal, μₜ, and its distribution, an etching depth index β can be precisely estimated in the form of a probability distribution pₜ(β|y_{1:(t-1)})=∫dμₜ q(β|μₜ)p(μₜ|y_{1:(t-1)}), where q(β|μₜ) is a probabilistic regression model, which can be a deterministic regression model using linear regression as p(β|μₜ)=δ(β−g(μₜ)) with δ( ) being Dirac's delta function. In this way, both the expected endpoint and its uncertainty can be precisely estimated. More broadly, this example illustrates the application of some embodiments of the present disclosure for learning the nonlinear, stochastic dynamics of a system only from noisy sensor data. A person of ordinary skill in the art can understand that the example of FIG. 9 and the method described herein can be applied to industrial, manufacturing, or other processes other than plasma etching.

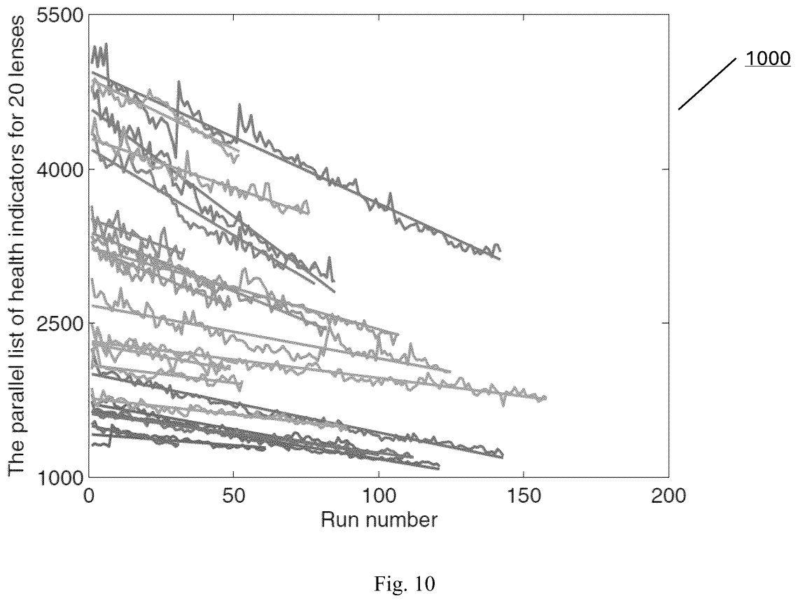

FIG. 10 is a graph 1000 illustrating lens replacement scheduling in optical measurement systems according to embodiments of the present disclosure. In optical measurement systems, the lens can become contaminated over time. However, the contamination level on the lens surface may not be directly measurable. Using sensor measurement data, such as OES spectra, a regression model according to some embodiments of the present disclosure can be built for predicting health indicators related to lens contamination, as illustrated in FIG. 10. Such a regression model q (β−μₜ) and the posterior distribution p(μₜ|y_{1:(t-1)}) can be used in combination according to some embodiments of the present disclosure: pₜ(β|y_{1:(t-1)})=∫dμₜ q(β|μₜ)p(μₜ|y_{1:(t-1)}). Such modeling according to some embodiments of the present disclosure allows for precise estimation of the lens contamination level and how long the lens can be used until the next replacement. In such an example, the present disclosure can be useful for predictive maintenance by precisely estimating internal system dynamics characterizing degradation of a tool.

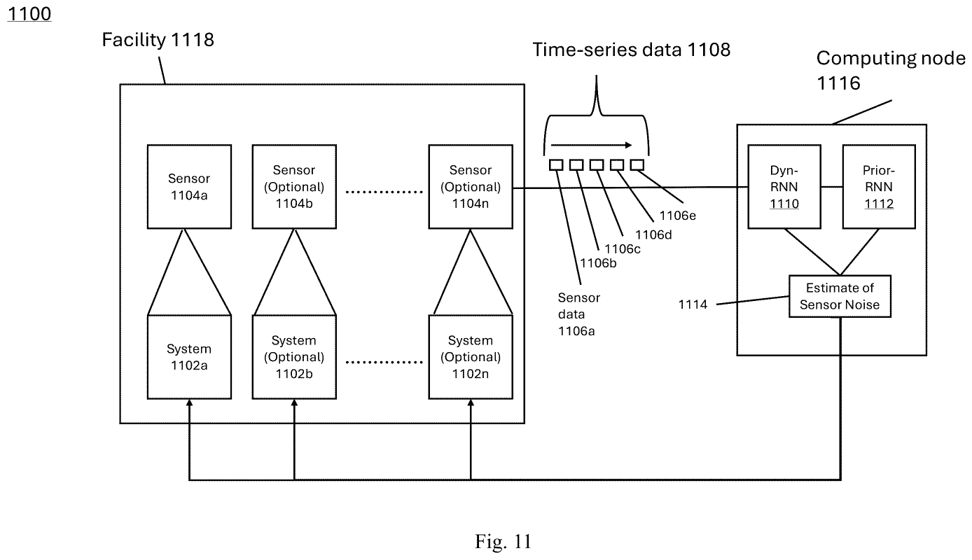

FIG. 11 is a diagram 1100 illustrating an example system of estimating ground truth and noise according to embodiments of the present disclosure. A facility 1118 (e.g., a facility for performing the plasma etching described in relation to FIG. 9) can include one or more systems 1102a-n (e.g., plasma-etching systems, semiconductor manufacturing systems) monitored by one or more sensors 1104a-n (e.g., real-time optical measurement spectra (OES) sensor(s)). Systems 1102b-n and corresponding sensors 1104b-n can be optional. The one or more sensors 1104a-n produce respective sensor data 1106a-e in a time series, resulting in time-series data 1108. Such time-series data 1108 is provided to a computing node 1116 having a Dyn-RNN 1110, a Prior-RNN 1112, and an estimate of sensor noise 1114 based on the time-series data 1108 received from the facility. Predictions of system states based on the Dyn-RNN 1110, Prior-RNN 1112, and estimate of sensor noise 1114 can then be employed to determine and deploy a corrective action to the one or more systems 1102a-n at the facility 1118.

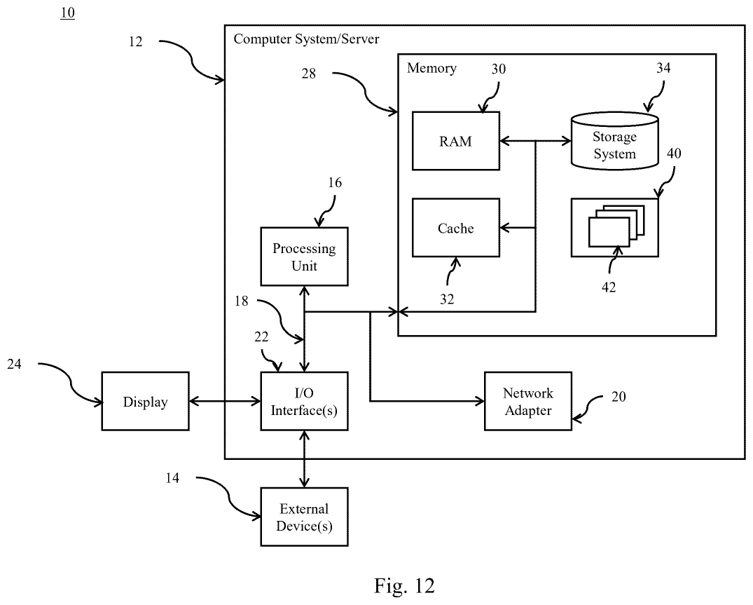

FIG. 12 is a schematic of an example of a computing node according to embodiments of the present disclosure. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
providing a first time-series data set to a pre-trained recurrent neural network, and receiving therefrom a prediction of a ground truth state of the first time-series data set, the pre-trained recurrent neural network trained based on a second time-series data set, the first time-series data set representing output of a sensor measuring a system, and the second time-series data set representing output of the sensor measuring the system;
providing the first time-series data set to a dynamical recurrent neural network, and receiving therefrom a noise-reduced prediction of a ground truth system state of the first time-series data set, the dynamical recurrent neural network trained based on the second time-series data set and the pre-trained recurrent neural network;
reading an estimate of sensor noise, the estimate of sensor noise generated based on the second time-series data set and the pre-trained recurrent neural network; and
generating a prediction of a state of the system based on the pre-trained recurrent neural network, the dynamical recurrent neural network, and the estimate of sensor noise.

2. The method of claim 1, wherein one or more of the first time-series data set and the second time-series data set comprise a composite noise, the composite noise comprising system noise and sensor noise.

3. The method of claim 1, wherein the dynamical recurrent neural network utilizes multiple-step forecast loss and moment matching of a training data set.

4. The method of claim 1, wherein the estimate of sensor noise is an estimated sensor noise of the ground truth state of the second time-series data set.

5. The method of claim 1, further comprising:
obtaining, using a sensor configured to monitor a system, one or more of the first time-series data set and the second time-series data set of the system, the ground truth state of one or more of the first time-series data set and the second time-series data set including a sensor noise component and a system noise component; and
separating the sensor noise component from the system noise component.

6. The method of claim 1, wherein the prediction of a ground truth state of the first time-series data set comprises a probability distribution of a state of the system.

7. The method of claim 1, wherein the training of the dynamical recurrent neural network comprises:
computing, based on a probability distribution from the pre-trained recurrent neural network, a prior distribution;
computing, based on the computed prior distribution and the estimate of sensor noise, a posterior distribution;
generating data based on the posterior distribution; and
training the dynamical recurrent neural network based on the generated data to obtain a probability distribution of a ground truth state of the system.

8. A system comprising:
a computing node comprising a computer readable storage medium having program instructions embodied therewith, the program instructions executable by a processor of the computing node to cause the processor to perform a method comprising:
providing a first time-series data set to a pre-trained recurrent neural network, and receiving therefrom a prediction of a ground truth state of the first time-series data set, the pre-trained recurrent neural network trained based on a second time-series data set, the first time-series data set representing output of a sensor measuring a system, and the second time-series data set representing output of the sensor measuring the system;
providing the first time-series data set to a dynamical recurrent neural network, and receiving therefrom a noise-reduced prediction of a ground truth system state of the first time-series data set, the dynamical recurrent neural network trained based on the second time-series data set and the pre-trained recurrent neural network;
reading an estimate of sensor noise, the estimate of sensor noise generated based on the second time-series data set and the pre-trained recurrent neural networks; and
generating a prediction of a state of the system based on the pre-trained recurrent neural networks, the dynamical recurrent neural network, and the estimate of sensor noise.

9. The system of claim 8, wherein one or more of the first time-series data set and the second time-series data set comprise a composite noise, the composite noise comprising system noise and sensor noise.

10. The system of claim 8, wherein the dynamical recurrent neural network utilizes multiple-step forecast loss and moment matching of a training data set.

11. The system of claim 8, wherein the estimate of sensor noise is an estimated sensor noise of the ground truth state of the second time-series data set.

12. The system of claim 8, wherein the processor-executable instructions, when executed by the processor, further cause the processor to:
obtain, using a sensor configured to monitor a system, one or more of the first time-series data set and the second time-series data set of the system, the ground truth state of one or more of the first time-series data set and the second time-series data set including a sensor noise component and a system noise component; and
separate the sensor noise component from the system noise component.

13. The system of claim 8, the prediction of a ground truth state of the first time-series data set comprises a probability distribution of a state of the system.

14. The system of claim 8, wherein the training of the dynamical recurrent neural network comprises:
computing, based on a probability distribution from the pre-trained recurrent neural network, a prior distribution;
computing, based on the computed prior distribution and the estimate of sensor noise, a posterior distribution;
generating data based on the posterior distribution; and
training the dynamical recurrent neural network based on the generated data to obtain a probability distribution of a ground truth state of the system.

15. A computer-implemented method comprising:
receiving a first time-series data set, the first time-series data set representing measurements made by a sensor of a system;
training a prior recurrent neural network (Prior-RNN) based on the first time-series data set, the trained Prior-RNN configured to predict a ground truth state of a second time-series data set;
training a dynamical recurrent neural network (Dyn-RNN) based on the first time-series data set and the Prior-RNN, the Dyn-RNN thereby trained to determine a noise-reduced prediction of a ground truth system state of the second time-series data set; and
generating an estimate of sensor noise of the system based on the Prior-RNN and the first time-series data set.

16. The method of claim 15, wherein one or more of the first time-series data set and the second time-series data set comprise a composite noise, the composite noise comprising system noise and sensor noise.

17. The method of claim 15, wherein the dynamical recurrent neural network utilizes multiple-step forecast loss and moment matching of a training data set.

18. The method of claim 15, further comprising:
obtaining, using a sensor configured to monitor a system, one or more of the first time-series data set and the second time-series data set of the system, the ground truth state of one or more of the first time-series data set and the second time-series data set including a sensor noise component and a system noise component; and
separating the sensor noise component from the system noise component.

19. The method of claim 15, wherein the first time-series data set comprises a ground truth state including a sensor noise component, and wherein training the Dyn-RNN is further based on the ground truth state and the sensor noise component.

20. The method of claim 15, wherein the prediction of a ground truth state of the second time-series data set comprises a probability distribution of a state of the system.
